(19) United States
(12) Patent Application Publication
(10) Pub. No.: US 2006/0061638 A1
(43) Pub. Date: Mar. 23, 2006

(54) Ink jet recording apparatus

(75) Inventors: Katsushi Amarume, Kanagawa (JP); Kishiharu Itazu, Kanagawa (JP); Kohei Murakami, Kanagawa (JP); Hiroshi Ikeda, Kanagawa (JP); Masashi Hiratsuka, Kanagawa (JP); Atsumichi Imazeki, Kanagawa (JP); Takaaki Sekiyama, Kanagawa (JP); Atsushi Murakami, Kanagawa (JP)

Correspondence Address: FILDES & OUTLAND, P.C., 20916 MACK AVENUE, SUITE 2, GROSSE POINTE WOODS, MI, 48236, US

(73) Assignee: Fuji Xerox Co., Ltd.

(21) Appl. No.: 11/062,979

(22) Filed: Feb. 22, 2005

(30) Foreign Application Priority Data
Sep. 21, 2004 (JP) 2004-274161

(51) Int. Cl. B41J 2/17

(52) U.S. Cl. 347/84

(57) ABSTRACT

An ink jet recording apparatus according to the present invention comprises an ink jet recording head for ejecting ink drops and a differential pressure valve provided in an ink feeding line connected to the ink jet recording head, the differential pressure valve generating a head back pressure in the ink jet recording head when ejecting no ink drop. Thus, the degree of freedom for the position of arrangement of an ink reservoir such as an ink tank connected to the ink feeding line is remarkably increased. Accordingly, it is possible to realize an ink jet recording apparatus of reduced size.

### CROSS-REFERENCE TO RELATED APPLICATION

This application claims priority under 35 USC 119 from Japanese Patent Application No. 2004-274161, the disclosure of which is incorporated by reference herein.

### BACKGROUND OF THE INVENTION

1. Field of the Invention

The present invention relates to an ink jet recording apparatus which ejects ink drops from an ink jet recording head and recording the ink drops on a recording medium.

2. Description of the Related Art

An ink jet recording apparatus ejecting ink drops from an ink jet recording head and recording the ink drops onto a recording medium is frequently used. Such an ink jet recording apparatus is provided with an ink reservoir, feeds ink from the ink reservoir to an ink jet recording head and ejects ink drops from a nozzle face of the ink jet recording head (refer to, for example, Japanese Patent Application Laid-Open (JP-A) No. 11-105303 and JP-A No. 10-138515).

In a conventional ink jet recording apparatus, an ink reservoir is disposed at a lower position than a nozzle face of an ink jet recording head in order to produce a head back pressure. This has caused a problem of restricting the degree of freedom for a position at which an ink reservoir is disposed, namely, a position at which an ink tank, a reservoir tank, a sub-tank or the like is disposed, thereby hindering reduction in the size of an apparatus. In addition, since a back pressure needs to be kept within an allowable range by adjusting the ink level, the amount of ink capable of being stored in an ink reservoir is limited, which has also hindered reduction in the size of an apparatus.

For example, as shown in FIG. 18, an ink jet recording apparatus 212 disclosed in JP-A No. 11-105303 has needed to keep ink levels R of a first buffer tank 214 and a second buffer tank 215 at positions lower than an ejecting opening 218 of an ink jet recording head 212. It has a difference in height h between the ink levels R of the first buffer tank 214 and the second buffer tank 215 and the ejecting opening 218 of the ink jet recording head 212 as a back pressure, and has needed to keep this difference h within an allowable range. These restrictions have hindered the reduction in the size of the ink jet recording apparatus 212.

### SUMMARY OF THE INVENTION

The present invention has been made in view of the abovecircumstances.

A first aspect of the invention provides an ink jet recording apparatus includes an ink jet recording head for ejecting ink drops and a back pressure generating portion being provided in an ink feeding line connected to the ink jet recording head and generating a head back pressure in the ink jet recording head.

A second aspect of the invention provides an ink jet recording apparatus includes an ink tank for storing ink therein, an ink feeding line being connected to the ink tank and including at least one longitudinal path, a recording head arranged at an end of the longitudinal path of the ink feeding line, an ink pressurizing portion arranged above the recording head in the longitudinal path, and a differential pressure valve arranged above the recording head in the longitudinal path.

### BRIEF DESCRIPTION OF THE DRAWINGS

FIG. 1 is a sectional front view showing the configuration of an ink jet recording apparatus of a first embodiment in a state of recording an image.

FIG. 2 is a sectional front view showing the configuration of the ink jet recording apparatus of the first embodiment in a state of maintenance.

FIG. 3 is a conceptual view showing the configuration of a conveyer belt of the ink jet recording apparatus of the first embodiment and its vicinity.

FIG. 4 is a block diagram showing the configuration of a control system of the ink jet recording apparatus of the first embodiment.

FIG. 5 is a schematic diagram showing an ink flowing line of the ink jet recording apparatus of the first embodiment.

FIG. 6A is a side view showing the configuration of an ink jet recording head in the first embodiment.

FIG. 6B is a bottom view showing the configuration of the ink jet recording head in the first embodiment.

FIG. 7 is a side view showing an ink jet recording head in the first embodiment.

FIG. 8A is a sectional side view showing a state where a diaphragm valve is closed in the first embodiment.

FIG. 8B is a sectional side view showing a state where the diaphragm valve is opened in the first embodiment.

FIG. 9A is a sectional side view showing a state where a float valve is closed in the first embodiment.

FIG. 9B is a sectional side view showing a state where the float valve is opened in the first embodiment.

FIG. 10 is a graph showing the relation between the pressure in a head and the elapsed time in the first embodiment.

FIG. 11 is a schematic diagram showing the ink flowing line of the ink jet recording apparatus of the first embodiment.

FIG. 12A is a side view showing the configuration of an ink jet recording head in a second embodiment.

FIG. 12B is a bottom view showing the configuration of the ink jet recording head in the second embodiment.

FIG. 13A is a side view showing the configuration of an ink jet recording head in a third embodiment.

FIG. 13B is a bottom view showing the configuration of the ink jet recording head in the third embodiment.

FIG. 14 is a schematic diagram showing an ink flowing line of an ink jet recording apparatus of a fourth embodiment.

FIG. 15 is a schematic diagram showing an ink flowing line of an ink jet recording apparatus of a fifth embodiment.

FIG. 16 is a schematic diagram showing an ink flowing line of an ink jet recording apparatus of a modified example of the fifth embodiment.

FIG. 17 is a schematic diagram showing an ink flowing line of an ink jet recording apparatus of a modified example of the fifth embodiment.

FIG. 18 is a side view showing the position of arrangement of components of a conventional ink jet recording apparatus.

### DETAILED DESCRIPTION OF THE INVENTION

Hereinafter, the embodiments of the present invention will be described. In second and subsequent embodiments, the same constituent elements as those described already are designated by the same reference numerals, and a duplicate description will be omitted.

### First Embodiment

A first embodiment will be described.

(Overall Configuration)

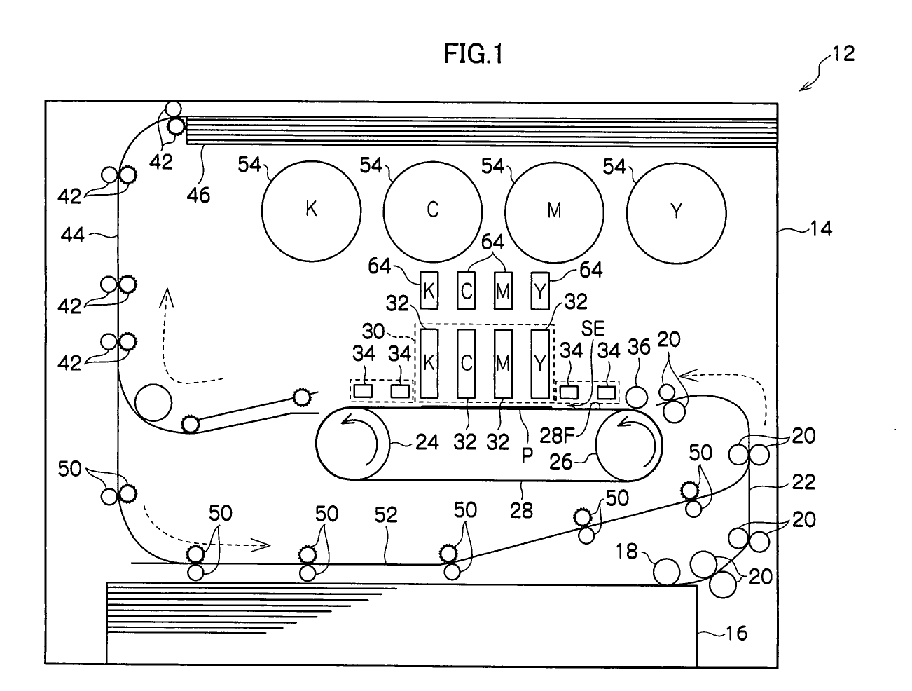

FIG. 1 shows an ink jet recording apparatus 12 of a first embodiment of the invention. A paper feeding tray 16 is provided on a lower part inside a cabinet 14 of the ink jet recording apparatus 12, and it is possible to take out recording papers P stuck in the paper feeding tray 16 one by one by means of a pickup roll 18. A recording paper P taken out is conveyed by a plurality of conveying roller pairs 20 forming a predetermined conveying path 22. Hereinafter, what is simply called “conveying direction” refers to the conveying direction of a recording paper P being a recording medium.

An endless conveyer belt 28 stretched out around a driving roll 24 and a driven roll 26 is disposed above the paper feeding tray 16. A recording head array 30 is arranged above the conveyer belt 28 and is opposite to a flat portion 28F of the conveyer belt 28. This opposite area is an ejecting area SE where ink drops are ejected from the recording head array 30. The recording paper P conveyed through the conveying path 22 is conveyed by the conveyer belt 28 and reaches this ejecting area SE, and has ink drops stuck according to image information from the recording head array 30 in a state of being opposite to the recording head array 30.

By revolving the recording paper P held on the conveyer belt 28, it is possible to perform what is called “multi-pass image recording” by passing the recording paper P through the ejecting area plural times. Therefore, the surface of the conveyer belt 28 becomes a circulating path of the recording paper P in the invention.

As an example of the conveyer belt 28, there can be used a conveyer belt formed of a semi-conductive polyimide material (10¹⁰ to 10¹³ Ω/□ in surface resistance and 10⁹ to 10¹² Ω·cm in volume resistance) of 75 μm in thickness, 380 mm in width and 1000 mm in circumferential length. Also, as an example of the driving roll 24 and the driven roll 26, a SUS roll of 50 mm in diameter can be used.

A configuration in which a recording medium (recording paper P) is turned while being sucked and held on the outer circumference of a conveying roller formed into a circular cylinder or a circular column without providing the conveyer belt 28 may be used. However, since the flat portion 28F is formed by using the conveyer belt 28 as in this embodiment, it is preferable that the recording head array 30 can be arranged opposite to this flat portion 28F.

In this embodiment, the recording head array 30 is of a long shape in which its effective recording area is equal to or larger than the width (length in a direction perpendicular to the conveying direction) of the recording paper P, and four ink jet recording head units 32 (hereinafter, simply referred to as “head units 32”) respectively corresponding to four colors of yellow (Y), magenta (M), cyan (C) and black (K) are arranged along the conveying direction, making it possible to record a full-color image. A method of ejecting ink drops in the respective head units 32 is not particularly limited, but may adopt a well-known method such as a so-called thermal method, a piezoelectric method or the like.

An ink jet recording head 33 forming each head unit 32 is controlled by a head controller 60. The head controller 60, for example, determines the ejecting timing of ink drops or an ejecting opening (nozzle) to be used according to image information and sends a driving signal to the ink jet recording head 33.

The recording head array 30 may be fixed perpendicularly to the conveying direction, but when it is made to move as needed, a more high-resolution image can be recorded in multi-pass image recording or made not to reflect a failure of the ink jet recording head 33 in a recording result.

Reservoir tanks 64 respectively corresponding to four colors of yellow (Y), magenta (M), cyan (C) and black (K) are arranged at an upper position than the head unit 32.

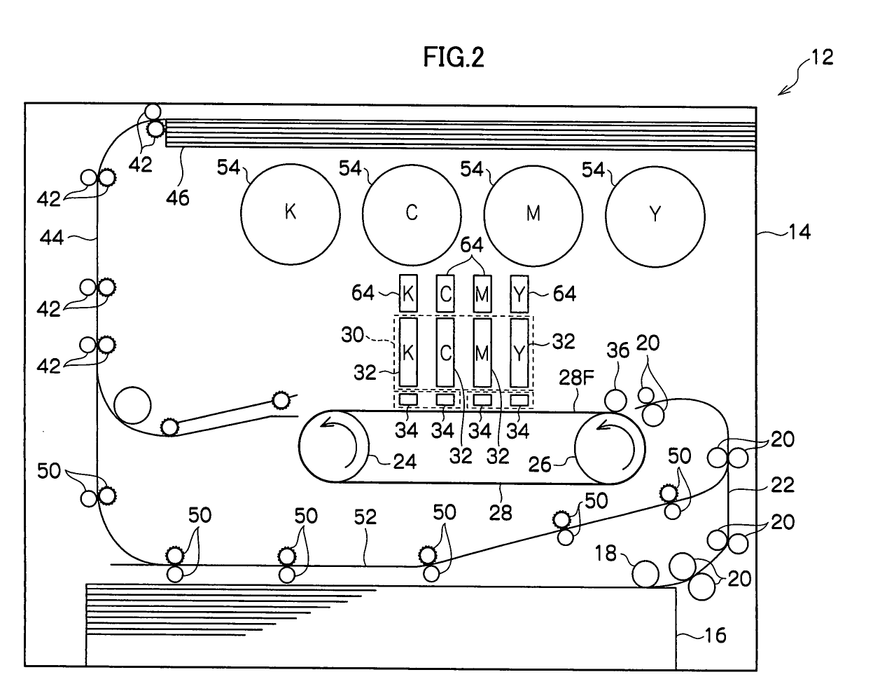

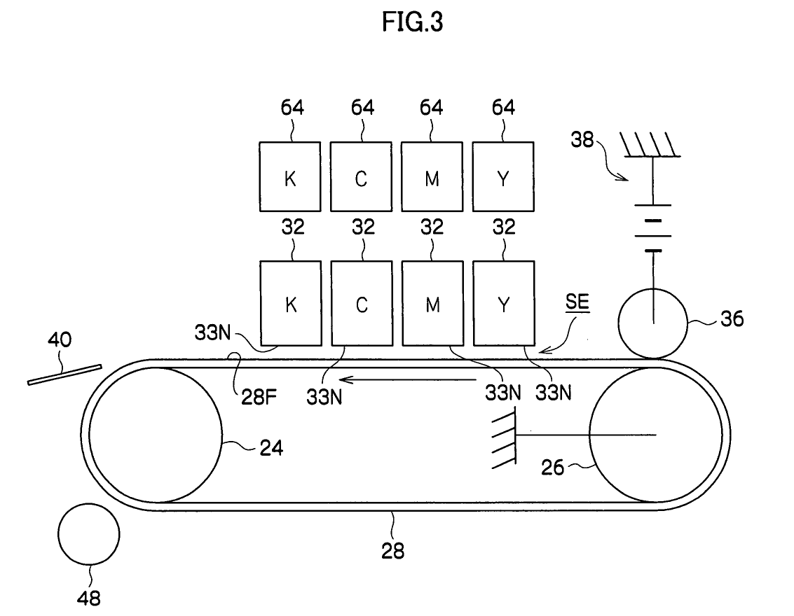

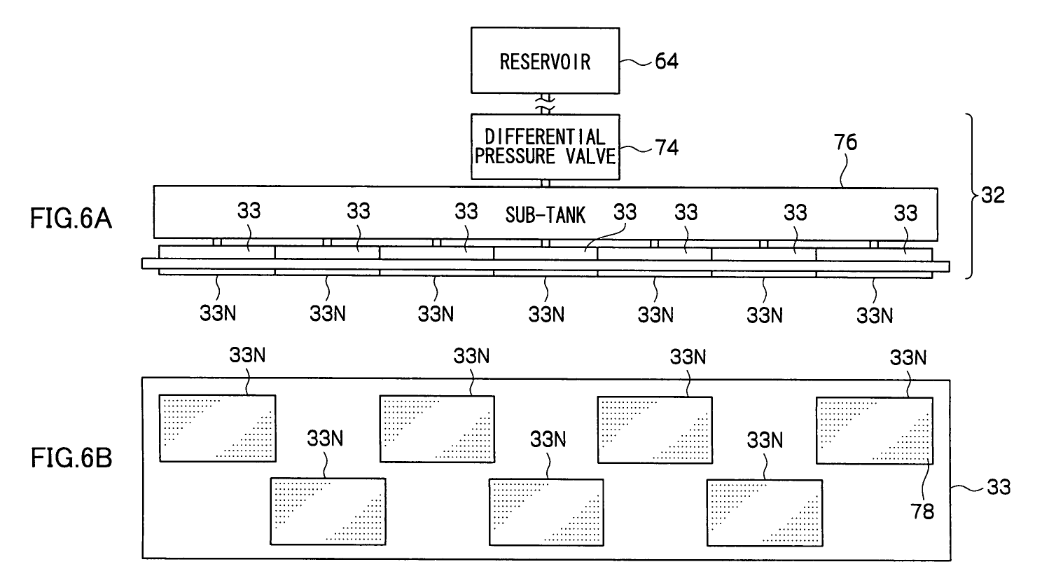

Four maintenance units 34 corresponding to the respective head units 32 are arranged in the vicinity (at both sides in the conveying direction in this embodiment) of the recording head array 30. In a case of performing maintenance on the head units 32, as shown in FIG. 2, the recording head array 30 moves upward and the maintenance units 34 move and enter a gap formed between the recording head array 30 and the conveyer belt 28. Then, the maintenance units 34 perform a predetermined maintenance operation (vacuuming, dummy jetting, wiping, capping and the like) in a state of being opposite to nozzle faces 33N being ejecting faces (see FIGS. 3, 6A and 6B).

In this embodiment, four maintenance units 34 are divided into two pairs, which are arranged respectively at the upstream side and the downstream side of the recording head array 30 in the conveying direction when the recording head array 30 records an image.

As shown in detail also in FIG. 3, a charging roll 36 connected to a power source 38 is arranged at the upstream side of the recording head array 30 in the conveying direction. The charging roll 36 is driven (rotated) while holding the conveyer belt 28 and the recording paper P between the charging roll 36 and the driven roll 26, and can move between a pressing position where the recording paper P is pressed against the conveyer belt 28 and a separating position where the recording paper P is separate from the conveyer belt 28. Since a predetermined potential difference is generated between the driven roll 26 grounded and the charging roll 36 at the pressing position, the recording paper P can be electrostatically stuck onto the conveyer belt 28 by being applied an electric charge.

As the charging roll 36, for example, there can be used a roll of 14 mm in diameter obtained by coating a surface of silicone rubber with conductive carbon, and adjusting the volume resistance to a degree of approximately 10⁶ to 10⁷ Ω·cm.

As the power source 38, a direct current power source is mentioned in FIG. 3 but an alternating current power source may be also used if it can charge the recording paper P to a predetermined potential.

A register roll (not illustrated) is provided at a more upstream side than the charging roll 36 in the conveying direction and the recording paper P is registered before it reaches between the conveyer belt 28 and the charging roll 36.

A releasing plate 40 (see FIGS. 1 and 2) is disposed at the downstream side of the recording head array 30 in the conveying direction, and can take off the recording paper P from the conveyer belt 28. As the releasing plate 40, for example, an aluminum plate of 0.5 mm in thickness, 330 mm in width and 100 mm in length can be used.

The released paper P is conveyed by a plurality of rotatable discharging roller pairs 42 forming a discharging path 44 at a more downstream side than the releasing plate 40 in the conveying direction and is discharged onto a paper discharge tray 46 provided at an upper part of the cabinet 14.

A cleaning roll 48 capable of holding the conveyer belt 28 between the cleaning roll 48 and the driving roll 24 is disposed below the releasing plate 40 and is made so as to clean the surface of the conveyer belt 28.

A reversing path 52 formed of a plurality of reversing roller pairs 50 as a reversing part is provided between the paper feeding tray 16 and the conveyer belt 28, making it easy to perform image recording on both sides of the recording paper P by reversing the paper P having an image recorded on one side thereof and by making the conveyer belt 28 hold the reversed paper P.

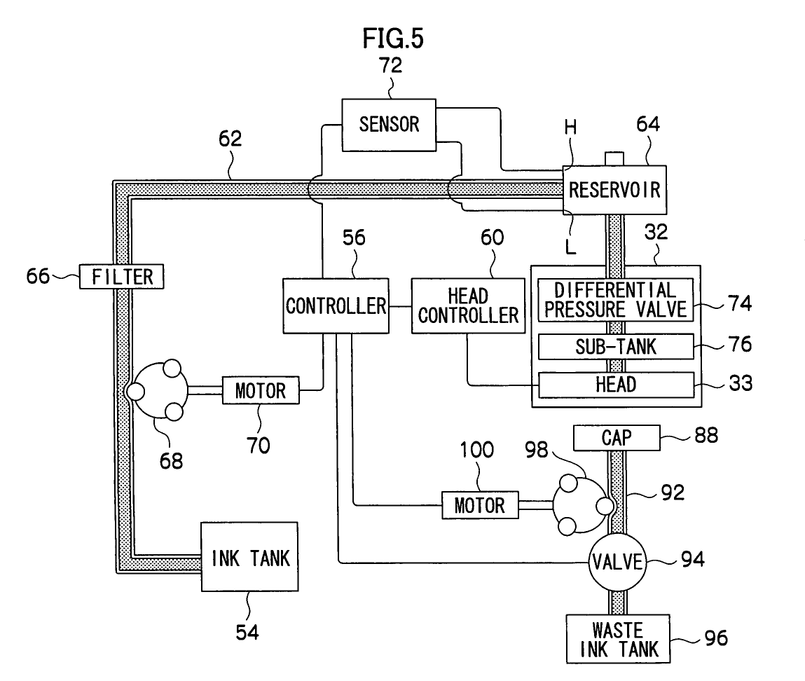

Ink tanks 54 respectively storing therein ink of four colors are provided between the conveyer belt 28 and the paper discharge tray 46. The ink in the ink tanks 54 is supplied to each head unit 32 through an ink feeding line 62 (see FIG. 5). As the ink, there can be used various kinds of well-known ink such as water ink, oil ink, solvent ink and the like.

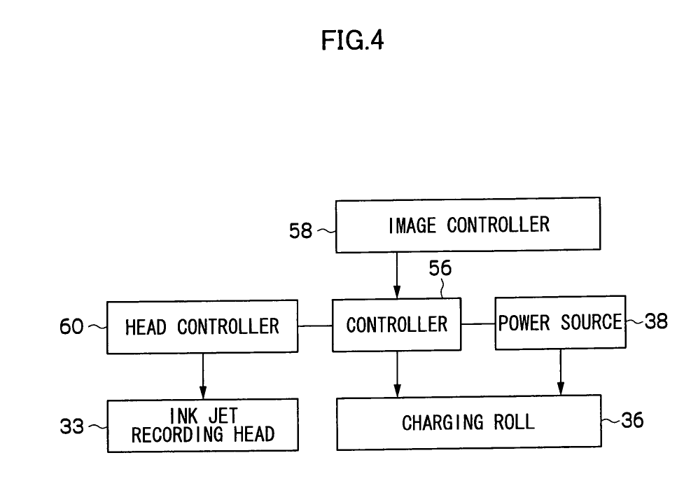

As shown in FIG. 4, the whole ink jet recording apparatus 12 is controlled by a controller 56, which controls operations including an operation of picking up the recording paper P, an image recording operation, a discharging operation and further a maintenance operation. Various kinds of data and the like with regard to image recording are sent from an image controller 58 to the controller 56. For example, as described later, applied voltages and the like in a first charging mode and a second charging mode are controlled by the controller 56 according to data and the like of an image to be recorded. In addition, the ink jet recording heads 33 are controlled by a head controller 60 and signals are sent from the controller 56 to the head controller 60. The controller 56, the head controller 60 and the charging roll 36 are configured so as to receive electric power supplied from the power source 38.

In the ink jet recording apparatus 12 of this embodiment having such an overall configuration, as described above, the recording paper P picked up from the paper feeding tray 16 is conveyed and reaches the conveyer belt 28. The paper P is then pressed against the conveyer belt 28 by the charging roll 36 and is stuck (made to adhere closely) and held onto the conveyer belt 28 by a voltage applied from the charging roll 36. In this state, while the recording paper P passes through the ejecting area SE by circulation of the conveyer belt 28, ink drops are ejected from the recording head array 30 and an image is recorded on the recording paper P. In a case of performing an image recording operation by only one pass, the paper P is removed from the conveyer belt 28 by the releasing plate 40, conveyed by the discharging roller pairs 42 and discharged onto the paper discharge tray 46. On the other hand, in a case of performing an image recording operation by multiple passes, after the recording paper P is made to circulate and pass through the ejecting area SE until the circulation reaches a necessary number of times, the paper P is removed from the conveyer belt 28 by the releasing plate 40, conveyed by the discharging roller pairs 42 and discharged onto the paper discharge tray 46.

(Ink Flowing Line)

As shown in FIG. 5, the ink jet recording apparatus 12 is provided with the ink feeding line 62 for feeding ink from the ink tank 54 to the head unit 32 for each color.

A mechanism for feeding ink from the ink tank 54 to the head unit 32 through the ink feeding line 62 is described for one color (yellow, for example) in the following. Since the other colors each have a similar mechanism, the description thereof will be omitted.

The ink feeding line 62 is provided with a filter 66 between the ink tank 54 and the reservoir tank 64.

The ink jet recording apparatus 12 is provided with a first pump (reservoir tank replenishing pump) 68 for exerting an ink delivering force to the ink feeding line 62 and a first motor 70 for driving the first pump 68, the first pump 68 and first motor 70 being provided at the upstream side of the filter 66 in the ink flow. The first motor 70 is controlled by the controller 56.

Further, a sensor 72 for detecting whether or not ink exists at a low position L and a high position H inside the reservoir tank 64 is provided in order to monitor the amount of ink inside the reservoir tank 64. Data measured by the sensor 72 is transmitted to the controller 56.

The reservoir tank 64 is provided with a valve for exposure to the atmosphere, and the liquid surface in the reservoir tank 64 is subjected to an atmospheric pressure.

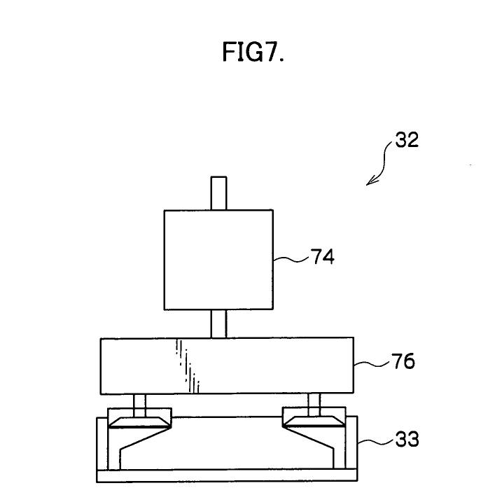

The head unit 32 is composed of a differential pressure valve 74, a sub-tank 76 provided under the differential pressure valve 74 and a plurality of ink jet recording heads 33 (see also FIGS. 6A, 6B and 7) provided under the sub-tank 76, and the differential pressure valve 74 generates a back pressure in the ink jet recording heads 33 through the sub-tank 76. In addition, the reservoir tank 64 and the differential pressure valve 74 are pipe-connected to each other, the differential pressure valve 74 and the sub-tank 76 are pipe-connected to each other, and the sub-tank 76 and the ink jet recording heads 33 are pipe-connected to each other such that the ink made to flow out from the reservoir tank 64 can reach the ink jet recording heads 33 through the differential pressure valve 74.

As shown in FIGS. 6A, 6B and 7, the lower face of the ink jet recording head 33 forms an ejecting face, which has 1024 nozzles 78 arranged therein.

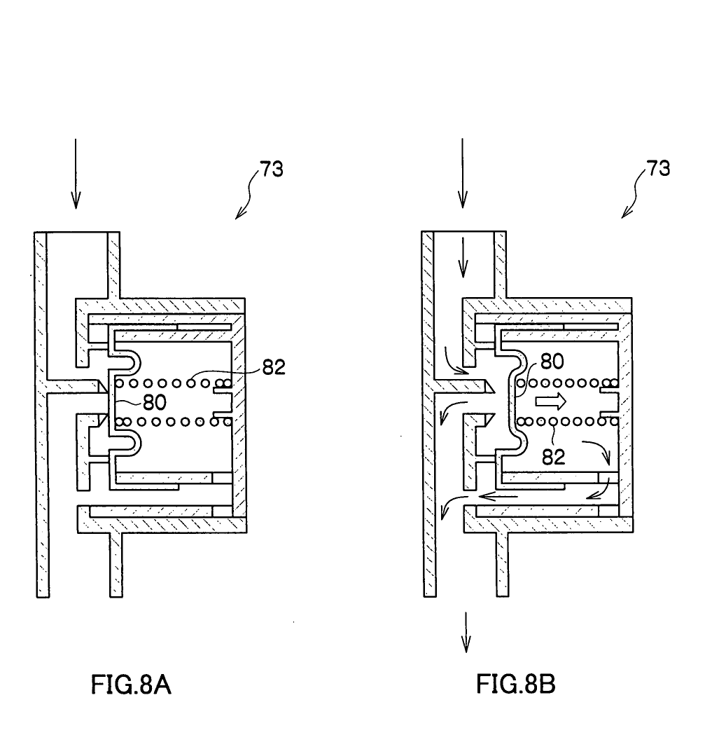

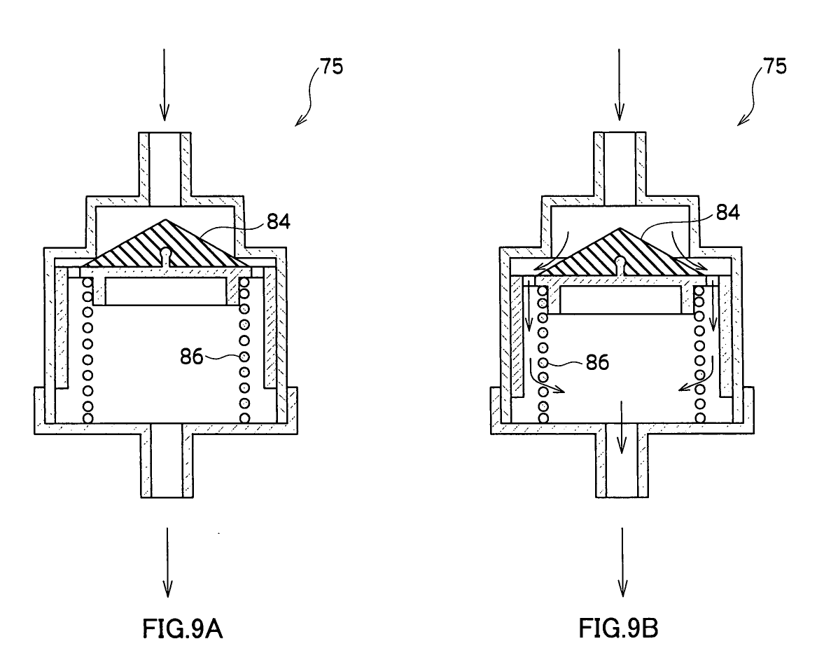

The differential pressure valve 74 is not particularly limited in particular. For example, as shown in FIGS. 8A and 8B, a diaphragm valve 73 provided as the differential pressure valve 74 may be opened by the shrinkage of a spring 82 due to a pressing force to a rubber plate 80 when a differential pressure being equal to or higher than a certain level occurs. Further, as shown in FIGS. 9A and 9B, a float valve 75 provided as the differential pressure valve 74 may be opened by the shrinkage of a spring 86 due to a pressing force to a conical rubber member 84 when a differential pressure being equal to or higher than a certain level occurs.

As shown in FIG. 5, the maintenance unit 34 is provided with a cap 88 for receiving ink from the nozzle face 33N at the time of a recovery operation of the ink jet recording apparatus 12 and a liquid discharge line 92 for discharging the ink received by the cap 88. A waste ink tank 96 is provided at the downstream end in ink flow of the liquid discharge line 92 through a valve 94. The ink jet recording apparatus 12 is provided with a second pump (pump for recovery operation of ink jet recording heads 33) 98 for exerting an ink delivering force (ink sucking-out force) from the cap 88 to the liquid discharge line 92 and a second motor 100 for driving the second pump 98. The second motor 100 is controlled by the controller 56 similarly to the first motor 70.

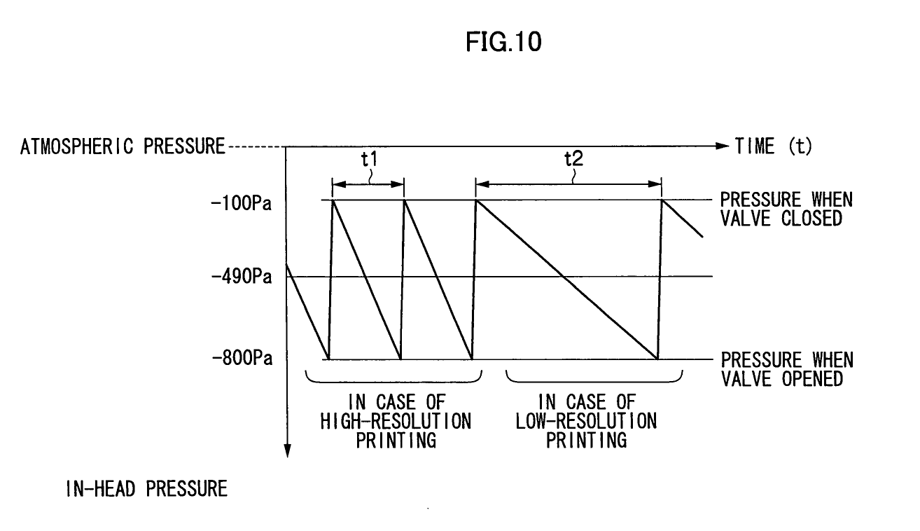

FIG. 10 shows an example of the relation between an in-head pressure and an elapsed time. An in-head pressure represented by the axis of ordinates is a relative pressure to an atmospheric pressure. In this embodiment, a time interval t1 of opening and closing the differential pressure valve 74 is short in a case of performing high-resolution printing, and a time interval t2 of opening and closing the differential pressure valve 74 is long in a case of performing low-resolution printing.

As described above, this embodiment can generate a head back pressure in the ink jet recording head 33 by the differential pressure valve 74 when ejecting no ink drop. Therefore, regardless of where the ink tank 54 connected to the ink feeding line 62 is disposed in the apparatus, this head back pressure can be generated. Thus, since the degree of freedom for the position of arrangement of components is remarkably increased, it is possible to realize a small-sized ink jet recording apparatus 12. Further, reduction in the size of the apparatus can be easily performed by the increased degree of freedom in the capacity and position of the reservoir tank.

The ink back pressure of the ink jet recording head 33 can be controlled utilizing the weight of ink in the reservoir tank 64, thereby enabling efficient control.

Since the head unit 32 is provided with one sub-tank 76 common to every nozzle in each ink jet recording head 33, an ejecting pressure can be made uniform in each ink jet recording head 33.

The differential pressure valve 74 is of a small and simple structure and can be disposed above the ink jet recording head 33. This fact is also advantageous for reducing the size of the ink jet recording apparatus 12.

The differential pressure valve 74 also acts as a check valve. Accordingly, even if a recording paper gets jammed and a head position varies, the ink jet recording head 33 does not draw in air bubbles through nozzles 78 thereof. In addition, even if the ink level fluctuates in the reservoir tank 64 due to vibration and the like, oozing-out of ink or drawing-in of air bubbles through the nozzles 78 does not occur.

### Second Embodiment

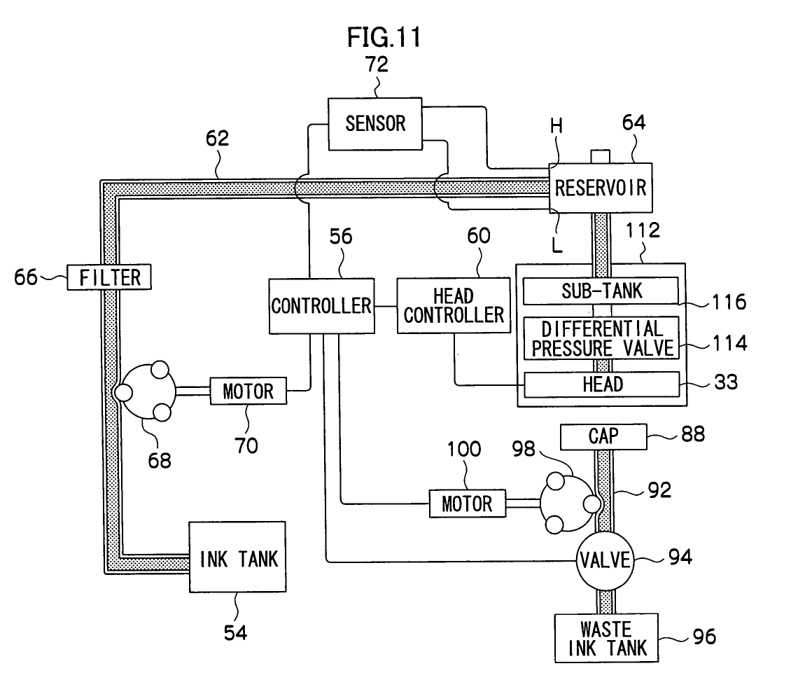

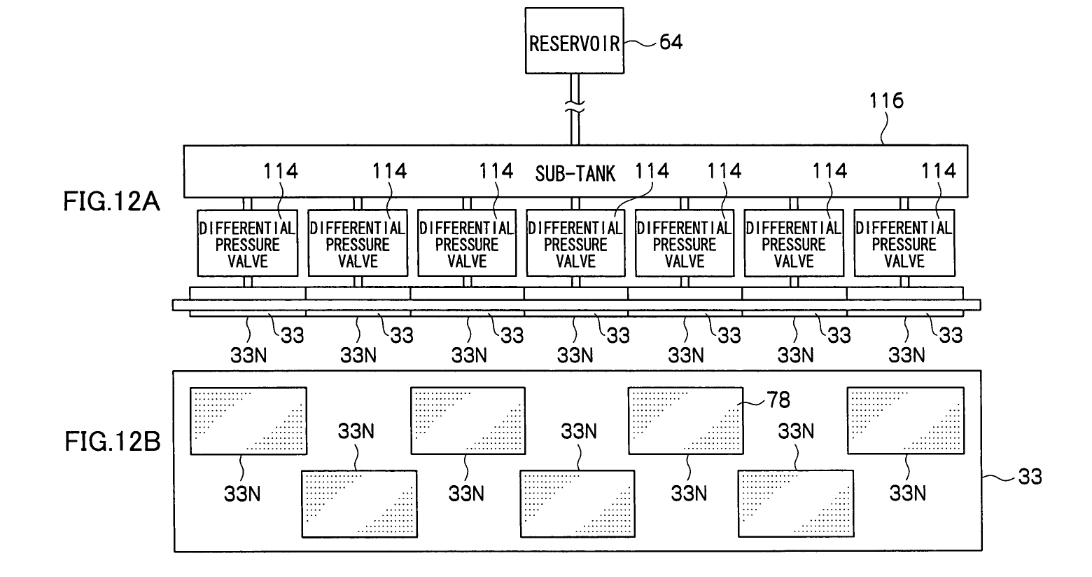

Next, a second embodiment will be described. As shown in FIGS. 11, 12A and 12B, in this embodiment, there are provided four head units 112 corresponding to four colors of yellow (Y), magenta (M), cyan (C) and black (K), wherein the configuration of the head units 112 is different from that of the first embodiment.

The head unit 112 is composed of a sub-tank 116, a plurality of differential pressure valves 114 provided under the sub-tank 116, and a plurality of ink jet recording heads 33 each being provided under each differential pressure valve 114, and the differential pressure valve 114 generates a head back pressure in the ink jet recording head 33. In addition, the reservoir tank 64 and the sub-tank 116 are pipe-connected to each other, the sub-tank 116 and the differential pressure valves 114 are pipe-connected to each other, and the differential pressure valves 114 and the ink jet recording heads 33 are pipe-connected to each other such that the ink flowing out from the reservoir tank 64 can reach the ink jet recording heads 33 through the differential pressure valves 114.

According to this embodiment, it is possible to control a head back pressure for each ink jet recording head 33. It is also possible to cause the differential pressure valve 114 to act as a check valve for each ink jet recording head 33.

### Third Embodiment

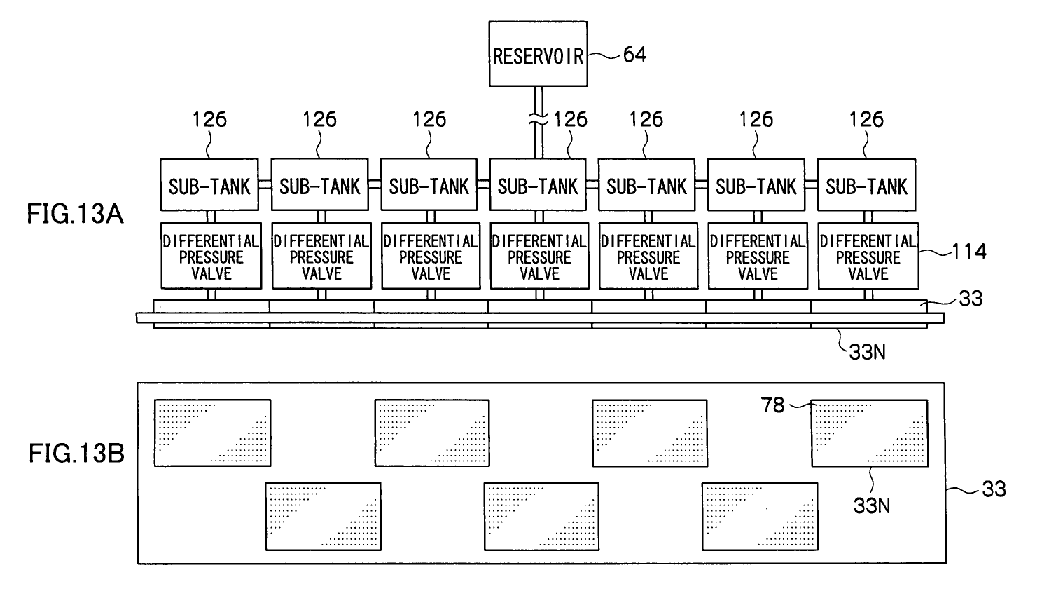

Next, a third embodiment will be described. As shown in FIGS. 13A and 13B, in this embodiment, a sub-tank 126 is provided for each differential pressure valve 114 in comparison with the second embodiment. The sub-tanks 126 being adjacent to each other are pipe-connected to each other, and the respective sub-tanks 126 are made basically uniform in pressure.

A similar effect to the second embodiment can be obtained by this embodiment.

### Fourth Embodiment

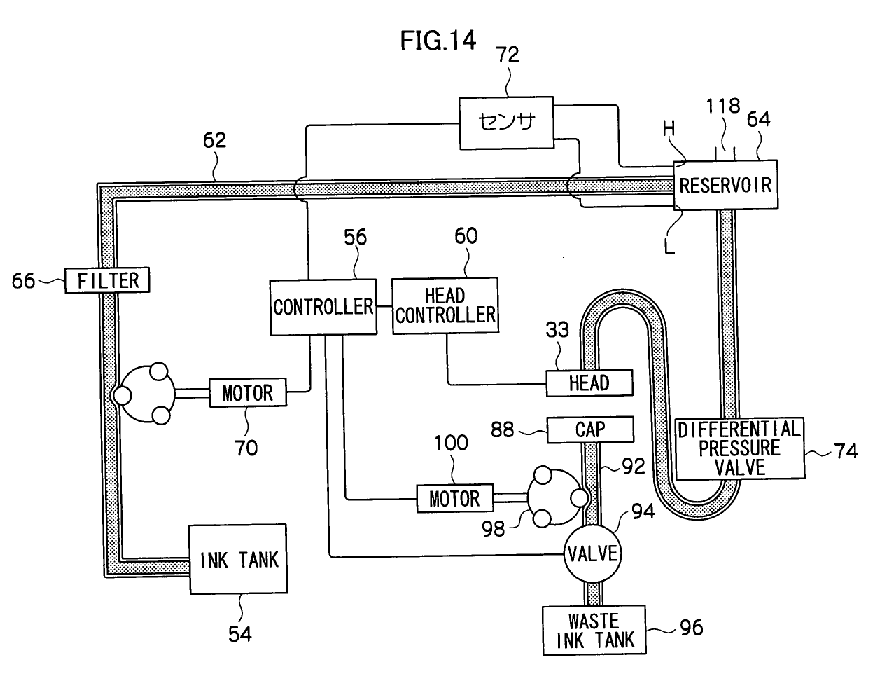

Next, a fourth embodiment will be described. As shown in FIG. 14, in this embodiment, the differential pressure valve 74 is provided between the reservoir tank 64 and the ink jet recording head 33 in comparison with the first embodiment, and this differential pressure valve 74 is located lower than the ink jet recording head 33. The reservoir tank 64 has an opening 118 exposed to the atmosphere and the ink liquid surface inside the reservoir tank 64 is opened to an atmospheric pressure.

Thus, ink is pressurized by making use of the weight of ink between the reservoir tank 64 and the differential pressure valve 74, and it is possible to control a back pressure of the ink jet recording head 33 by operating the differential pressure valve 74.

### Fifth Embodiment

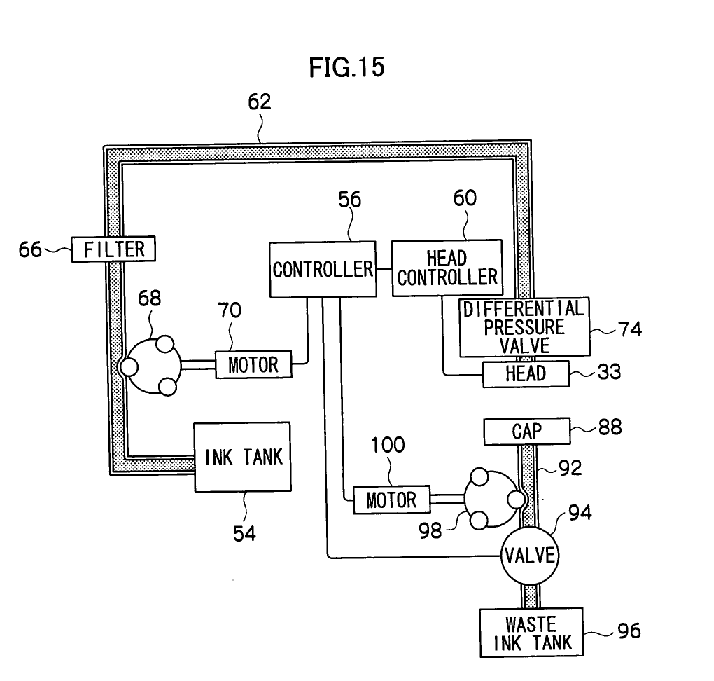

Next, a fifth embodiment will be described. As shown in FIG. 15, in this embodiment, ink is directly pressurized and fed by the first pump 68 to the ink jet recording head 33 without being provided with the reservoir tank 64 and sensor 72 in comparison with the first embodiment.

Thus, the apparatus can be made more small and simple without having to be provided with the reservoir tank and sensor.

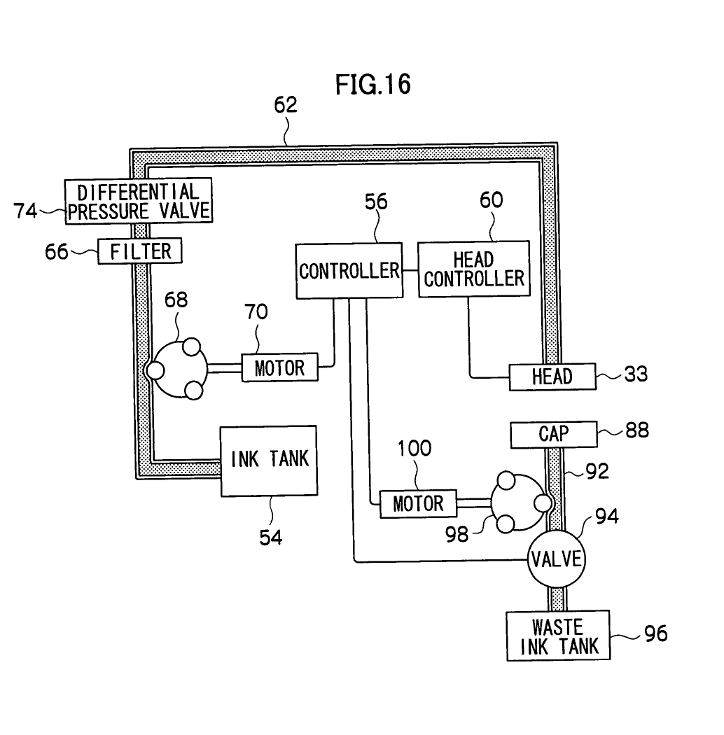

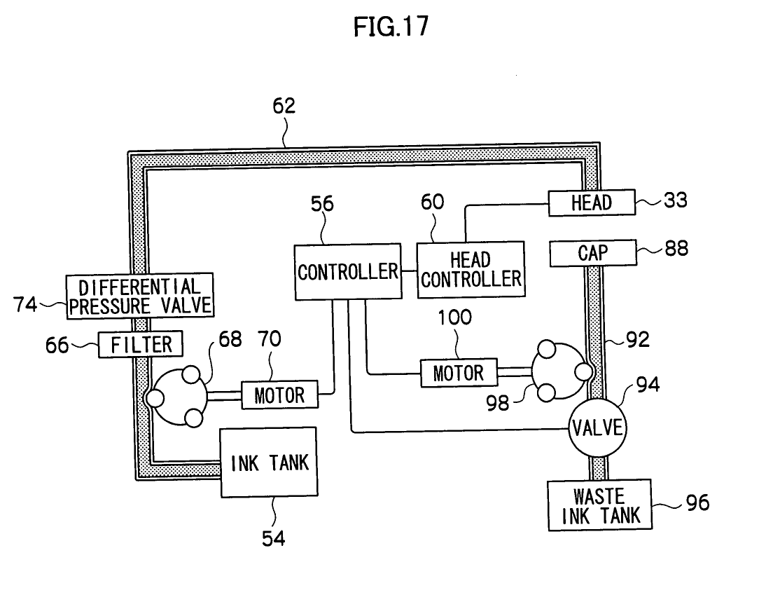

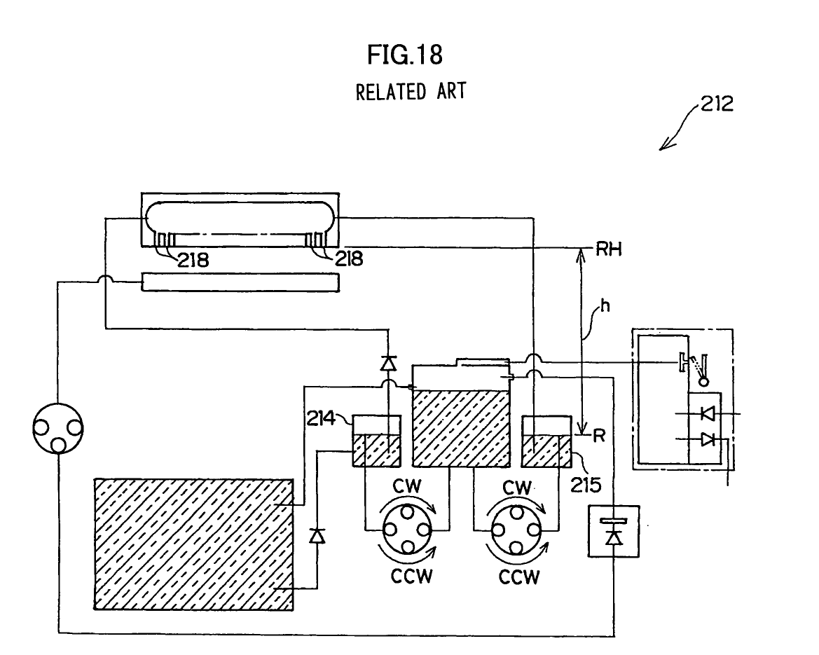

As shown in FIG. 16, the differential pressure valve 74 may be provided directly at the upstream side of the filter 66, and as shown in FIG. 17, the differential pressure valve 74 may be located lower than the ink jet recording head 33.

As described above, according to an embodiment of the invention, an ink jet recording apparatus is characterized by comprising an ink jet recording head for ejecting ink drops and a back pressure generating portion being provided in an ink feeding line connected to the ink jet recording head and generating a head back pressure in the ink jet recording head.

Such a configuration remarkably expands the degree of freedom for the position of arrangement of an ink reservoir such as an ink tank connected to an ink feeding line. Accordingly, it is possible to realize an ink jet recording apparatus enabling the reduction in the size thereof.

According to an another embodiment of the invention, an ink jet recording apparatus may be characterized in that the back pressure generating portion includes a differential pressure valve and an ink pressurizing portion provided at the upstream side of the differential pressure valve.

Since it is possible to control the ink back pressure of the ink jet recording head by means of the differential pressure valve and the ink pressurizing portion, the degree of freedom for the position and capacity of an ink reservoir is increased further and facilitates the reduction in the size of the apparatus.

The differential pressure valve is of a small and simple structure in which the valve is opened or closed under a certain differential pressure and can be disposed at a higher position than the head. Accordingly, an apparatus configuration can be made more simple and the size of an apparatus can be made smaller.

In addition, the differential pressure valve acts also as a check valve. Therefore, even if a recording paper used as a recording medium gets jammed and a head position varies, the ink jet recording head has no air bubble drawn in through an ejection opening (nozzle or the like) thereof. Further, even if an ink level fluctuates in a reservoir tank due to vibration and the like, oozing-out of ink or drawing-in of air bubble through a nozzle does not occur.

According to an another embodiment of the invention, an ink jet recording apparatus may be characterized in that the pressurizing portion is a reservoir tank having an opening communicating with the atmosphere, and the reservoir tank is provided at a higher position than the ink jet recording head.

Thus, it is possible to pressurize ink by utilizing the weight of ink between the reservoir tank and the differential pressure valve, operate the differential pressure valve and thereby control a back pressure of the ink jet recording head.

Further, since it is of a simple structure in which the reservoir tank is arranged above the ink jet recording head, it is particularly suitable for reducing the size of the apparatus.

As the differential pressure valve, there can be mentioned a diaphragm valve, a float valve and the like can be used.

Since each of these embodiments of the invention has the above-described configuration, it can realize an ink jet recording apparatus of reduced size.

Although embodiments of the present invention have been given as described above, they are only examples and can be modified in various manners within the scope not departing from the gist of the invention. Further, the scope of the claims of the present invention is not limited to the above-described embodiments.

What is claimed is:

1. An ink jet recording apparatus comprising:
an ink jet recording head for ejecting ink drops; and
a back pressure generating portion being provided in an ink feeding line connected to the ink jet recording head and generating a head back pressure in the ink jet recording head.

2. An ink jet recording apparatus according to claim 1, wherein the back pressure generating portion includes a differential pressure valve and an ink pressurizing portion provided at the upstream side of the differential pressure valve.

3. An ink jet recording apparatus according to claim 2, wherein the ink pressurizing portion is a reservoir tank having an opening to communicate with the atmosphere, the reservoir tank being provided at a higher position than the ink jet recording head.

4. An ink jet recording apparatus according to claim 2, wherein the differential pressure valve is a diaphragm valve.

5. An ink jet recording apparatus according to claim 3, wherein the differential pressure valve is a diaphragm valve.

6. An ink jet recording apparatus according to claim 2, wherein the differential pressure valve is a float valve.

7. An ink jet recording apparatus according to claim 3, wherein the differential pressure valve is a float valve.

8. An ink jet recording apparatus comprising:
an ink tank for storing ink therein;
an ink feeding line being connected to the ink tank and including at least one longitudinal path;
a recording head arranged at an end of the longitudinal path of the ink feeding line;
an ink pressurizing portion arranged above the recording head in the longitudinal path; and
a differential pressure valve arranged above the recording head in the longitudinal path.

9. An ink jet recording apparatus according to claim 8, wherein the ink pressurizing portion and the differential pressure valve are arranged above the recording head in the longitudinal path in the order of the differential pressure valve and the ink pressurizing valve upward from below.

10. An ink jet recording apparatus according to claim 8, wherein the ink pressurizing portion is a reservoir tank.

11. An ink jet recording apparatus according to claim 9, wherein the ink pressurizing portion is a reservoir tank.

12. An ink jet recording apparatus according to claim 8, further comprising a sub-tank arranged above the recording head in the longitudinal path.

13. An ink jet recording apparatus according to claim 9, further comprising a sub-tank arranged above the recording head in the longitudinal path.

14. An ink jet recording apparatus according to claim 13, wherein the sub-tank is arranged between the recording head and the differential pressure valve.

15. An ink jet recording apparatus according to claim 13, wherein the sub-tank is arranged between the differential pressure valve and the ink pressurizing portion.

16. An ink jet recording apparatus according to claim 8, wherein the differential pressure valve is a diaphragm valve.

17. An ink jet recording apparatus according to claim 8, wherein the differential pressure valve is a float valve.

18. An ink jet recording apparatus according to claim 8, further comprising:
a pump for providing an ink delivering force to the ink feeding line;
a motor for driving the pump;
a motor controller for controlling the motor; and
a filter provided between the ink tank and the ink pressurizing portion in the ink feeding line.

19. An ink jet recording apparatus according to claim 10, further comprising a sensor connected to the reservoir tank and the motor controller, for detecting whether or not ink exists at a low position or a high position in the reservoir tank in order to monitor the amount of ink in the reservoir tank.

20. An ink jet recording apparatus according to claim 19, further comprising a head controller connected to the recording head and the motor controller, for controlling the recording head.
